(19) United States
(12) Patent Application Publication
(10) Pub. No.: US 2026/0073873 A1
(43) Pub. Date: Mar. 12, 2026

(54) PIXEL CIRCUIT AND DISPLAY DEVICE INCLUDING THE SAME

(71) Applicant: LG DISPLAY CO., LTD., Seoul (KR)

(72) Inventors: Yong Chul KWON, Paju-si (KR); Young Woo JO, Paju-si (KR)

(73) Assignee: LG DISPLAY CO., LTD., Seoul (KR)

(21) Appl. No.: 19/247,257

(22) Filed: Jun. 24, 2025

(30) Foreign Application Priority Data
Sep. 12, 2024 (KR) 10-2024-0124432

(51) Int. Cl. G09G 3/3241; G09G 3/20; G09G 3/32; G09G 3/3266

(52) U.S. Cl. CPC G09G 3/3241; G09G 3/3266; G09G 3/2007; G09G 3/32; G09G 2300/0819; G09G 2300/0852; G09G 2300/0866; G09G 2310/0286; G09G 2310/08; G09G 2320/029; G09G 2320/045

(57) ABSTRACT

A pixel circuit may include: a first transistor including a first electrode connected to a first node, a gate electrode connected to a second node, and a second electrode connected to a third node; a light-emitting element connected to the third node; and a pulse width modulation (PWM) driver connected to the first transistor and configured to adjust a lighting time of the light-emitting element according to a data voltage of pixel data. A first power line to which a pixel driving voltage is applied is connected to the first node. An anode electrode of the light-emitting element is connected to the third node, and a cathode electrode of the light-emitting element is connected to a second power line to which a ground voltage lower is applied in a display mode. A display device including the pixel circuit is also disclosed.

### CROSS-REFERENCE TO RELATED APPLICATION

This application claims the benefit of and priority to Korean Patent Application No. 10-2024-0124432, filed Sep. 12, 2024, the entire contents of which are incorporated herein by reference for all purposes.

### BACKGROUND

### 1. Technical Field

The present disclosure relates to a pixel circuit and a display device including the same.

### 2. Description of Related Art

Various flat panel displays such as a liquid crystal display and an electroluminescence display are known. An electroluminescence display can display an input image by emitting light by itself using light-emitting elements respectively provided in pixels without a backlight. The light-emitting elements of the electroluminescence display may be divided into organic light-emitting elements and inorganic light-emitting elements depending on a material for a light-emitting layer.

Recently, a display device using a light-emitting diode (LED) that is an inorganic light-emitting element, for example, a micro LED as a light-emitting element for a pixel has been attracting attention as a next-generation display device. Since the LED is made of an inorganic material, the LED does not require a separate encapsulation layer for protecting an organic material from moisture and has excellent reliability and long lifetime compared to an organic light-emitting diode (OLED). In addition, the micro LED has a high turn-on speed, is excellent in light emission efficiency, and has impact resistance.

In the case of a pixel circuit for driving a micro light-emitting diode (LED), a color deviation may occur due to a shift in the wavelength of light depending on an amount of current or a current density flowing through the micro LED. To solve this, a pulse width modulation (PWM) driving method, which maintains a constant current density of the micro LED and adjusts a light-emitting time of the micro LED to express grayscale of pixel data, has been proposed. A PWM pixel circuit may further include a constant current source, a data line connected to the constant current source, a capacitor, and the like. Such a PWM pixel circuit includes a large number of transistors, and high-speed driving is required during digital driving, making it difficult to implement high resolution.

The description of related art should not be considered prior art merely because it is mentioned in or associated with this section. The description of related art includes information that describes one or more aspects of the subject technology, and the description in this section does not limit the scope of the invention.

### SUMMARY

An aspect of the present disclosure is to solve the above-described necessity and/or problems.

One or more aspects of the present disclosure provide a pixel circuit and a display device including the same, in which PWM driving is possible without adding a data line and a circuit configuration is not complicated.

Aspects of the present disclosure are not limited to those mentioned above, and other aspects not mentioned will be clearly understood by those skilled in the art from the following description.

A pixel circuit according to one embodiment of the present disclosure includes: a first transistor including a first electrode connected to a first node, a gate electrode connected to a second node, and a second electrode connected to a third node; a light-emitting element connected to the third node; and a pulse width modulation (PWM) driver connected to the first transistor and configured to adjust a lighting time of the light-emitting element according to a data voltage of pixel data. A first power line configured to receive a pixel driving voltage is connected to the first node. An anode electrode of the light-emitting element is connected to the third node, and a cathode electrode of the light-emitting element is connected to a second power line configured to receive a ground voltage lower than the pixel driving voltage in a display mode.

The PWM driver may be connected to a data line configured to receive the data voltage, a first gate line configured to receive a first gate signal, a second gate line configured to receive a second gate signal, the first node, the second node, and the second power line.

The first gate signal may include pulses that swing between a gate high voltage and a gate low voltage in each frame period in a display mode. The second gate signal may be generated as a ramp waveform signal that increases from a minimum voltage to a maximum voltage in each frame period in the display mode. The gate high voltage may be higher than the pixel driving voltage, and the gate low voltage may be lower than the ground voltage. The maximum voltage of the ramp waveform may be lower than the gate high voltage and higher than the pixel driving voltage, and the minimum voltage of the ramp waveform may be lower than the ground voltage and higher than the gate low voltage.

A lighting period of the light-emitting element may become longer as the data voltage increases.

The PWM driver may include: a capacitor arranged between a fourth node and the second gate line; a second transistor including a first electrode connected to the second node, a gate electrode connected to the first gate line, and a second electrode connected to the second power line; a third transistor including a first electrode connected to the data line, a gate electrode connected to the first gate line, and a second electrode connected to the fourth node; and a fourth transistor including a first electrode connected to the second node, a gate electrode connected to the fourth node, and a second electrode connected to the first node.

The light-emitting element may start emitting light when the fourth transistor is turned on. The earlier the turn-on timing of the fourth transistor is, the longer the lighting period of the light-emitting element may become.

The PWM driver may be connected to a data line configured to receive the data voltage, a first gate line configured to receive a first gate signal, a second gate line configured to receive a second gate signal, a third gate line configured to receive a third gate signal, the first node, the second node, and the second power line.

The pixel circuit further include: a first switch element configured to supply the first gate signal to the third gate line in the display mode, and to supply the third gate signal to the third gate line in a sensing mode; and a sensing circuit connected to the light-emitting element and configured to operate in the sensing mode.

The sensing circuit may include: an analog-to-digital converter; and a second switch element configured to supply the ground voltage to a cathode electrode of the light-emitting element in the display mode and to connect the cathode electrode of the light-emitting element to an input terminal of the analog-to-digital converter in the sensing mode.

The first gate signal may be a gate high voltage during an initialization period and a sensing period in the sensing mode, and may be a gate low voltage during a sampling period in the sensing mode. In the sensing mode, a voltage of the second gate signal may be maintained at a reference voltage during the initialization period, the sampling period, and the sensing period. In the sensing mode, a voltage of the third gate signal may be the gate low voltage during the initialization period and the sensing period, and may be the gate high voltage during the sampling period.

The PWM driver may include: a capacitor arranged between a fourth node and the second gate line; a second transistor including a first electrode connected to the second node, a gate electrode connected to the first gate line, and a second electrode connected to the second power line; a third transistor including a first electrode connected to the data line, a gate electrode configured to receive the third gate signal in the sensing mode, and a second electrode connected to the fourth node; and a fourth transistor including a first electrode connected to the second node, a gate electrode connected to the fourth node, and a second electrode connected to the first node.

A display device according to one embodiment of the present disclosure includes: a display panel in which a plurality of data lines, a plurality of gate lines, a plurality of power lines, and a plurality of subpixels are arranged; a data driver connected to the data lines; and a gate driver connected to the gate lines. Each of the subpixels includes the pixel circuit.

According to embodiments of the present disclosure, a light-emitting element may be driven with high efficiency and high luminance, thereby improving lifetime and enabling low power driving, and PWM driving of the light-emitting element may be performed without adding a data line, and a configuration of a pixel circuit may be simplified.

Embodiments of the present disclosure may improve image quality and lifetime of a display device by sensing a threshold voltage of a transistor affecting a lighting period of the light-emitting element and compensating for a threshold voltage deviation of the transistor among subpixels or a threshold voltage shift due to stress accumulation of the transistor.

The effects of the present disclosure are not limited to the effects mentioned above, and other effects not mentioned will be clearly understood by those skilled in the art from the description of the claims.

Additional features, advantages, and aspects of the present disclosure are set forth in part in the description that follows and in part will become apparent from the present disclosure or may be learned by practice of the inventive concepts provided herein. Other features, advantages, and aspects of the present disclosure may be realized and attained by the descriptions provided in the present disclosure, or derivable therefrom, and the claims hereof as well as the drawings. It is intended that all such features, advantages, and aspects be included within this description, be within the scope of the present disclosure, and be protected by the following claims. Nothing in this section should be taken as a limitation on those claims. Further aspects and advantages are discussed below in conjunction with embodiments of the present disclosure.

It is to be understood that both the foregoing description and the following description of the present disclosure are examples, and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure. In the drawings:

FIG. 1 is a block diagram showing a display device according to an embodiment of the present disclosure;

FIG. 2 is a block diagram showing a display device according to another embodiment of the present disclosure;

FIG. 3 is a diagram showing a display mode and a sensing mode;

FIG. 4 is a diagram showing an example of a gate driver shown in FIGS. 1 and 2;

FIG. 5 is a circuit diagram showing a ramp signal output part according to an embodiment of the present disclosure;

FIG. 6 is a waveform diagram showing an example of input and output signals of the ramp signal output part shown in FIG. 5;

FIG. 7 is a waveform diagram showing an example in which pulses of a second gate signal are sequentially shifted;

FIG. 8 is a circuit diagram showing a pixel circuit according to another embodiment of the present disclosure;

FIG. 9 is a diagram showing an example in which a lighting period of a light-emitting element is varied according to grayscale of pixel data;

FIG. 10 is a circuit diagram showing in detail an example of the pixel circuit shown in FIG. 8;

FIG. 11 is a waveform diagram showing an example of input and output signals of the pixel circuit shown in FIG. 10 in a display mode;

FIG. 12 is a waveform diagram showing a lighting period of a light-emitting element according to grayscale of pixel data in the pixel circuit shown in FIG. 10;

FIG. 13 is a waveform diagram showing an example in which a lighting period of a light-emitting element is changed when a threshold voltage of a fourth transistor changes in the pixel circuit shown in FIG. 10;

FIG. 14 is a circuit diagram showing a pixel circuit according to another embodiment of the present disclosure; and

FIG. 15 is a waveform diagram showing gate signals applied to the pixel circuit shown in FIG. 14 in a sensing mode.

Throughout the drawings and the detailed description, unless otherwise described, the same drawing reference numerals should be understood to refer to the same elements, features, and structures. The sizes, lengths, and thicknesses of layers, regions and elements, and depiction thereof may be exaggerated for clarity, illustration, and/or convenience.

### DETAILED DESCRIPTION

The advantages and features of the present disclosure and methods for accomplishing the same will be more clearly understood from embodiments described below with reference to the accompanying drawings. However, the present disclosure is not limited to the following embodiments but may be implemented in various different forms. Rather, the present embodiments will make the disclosure of the present disclosure complete and allow those skilled in the art to completely comprehend the scope of the present disclosure.

The shapes, sizes, ratios, angles, numbers, and the like illustrated in the accompanying drawings for describing the embodiments of the present disclosure are merely examples, and the present disclosure is not limited thereto. Like reference numerals generally denote like elements throughout the present specification. Further, in describing the present disclosure, detailed descriptions of known related technologies may be omitted to avoid unnecessarily obscuring the subject matter of the present disclosure.

The terms such as “comprising,” “including,” “having,” and “consist of” used herein are generally intended to allow other components to be added unless the terms are used with the term “only. ” Any references to singular may include plural unless expressly stated otherwise. For example, an element may be one or more elements. An element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.” Components are interpreted to include an ordinary error range even if not expressly stated.

When a positional or interconnected relationship is described between two components, such as “on top of,” “above,” “below,” “next to,” “connect or couple with,” “crossing,” “intersecting,” or the like, one or more other components may be interposed between them, unless “immediately”or “directly”is used.

When a temporal antecedent relationship is described, such as “after,” “following,” “next to,” “before,” or the like, it may not be continuous on a time base unless “immediately” or “directly”is used.

The terms “first,” “second,” and the like may be used to distinguish elements from each other, but the functions or structures of the components are not limited by ordinal numbers or component names in front of the components.

The following embodiments can be partially or entirely bonded to or combined with each other and can be linked and operated in technically various ways. The embodiments can be carried out independently of or in association with each other.

The pixel circuit of the display device may include a plurality of transistors. A transistor is a three-electrode element including a gate, a source, and a drain. The source is an electrode that supplies carriers to the transistor. In the transistor, carriers start to flow from the source. The drain is an electrode through which carriers exit from the transistor. In a transistor, carriers flow from a source to a drain. In the case of an n-channel transistor, since carriers are electrons, a source voltage is a voltage lower than a drain voltage such that electrons may flow from a source to a drain. The n-channel transistor has a direction of a current flowing from the drain to the source. In the case of a p-channel transistor, since carriers are holes, a source voltage is higher than a drain voltage such that holes may flow from a source to a drain. In the p-channel transistor, since holes flow from the source to the drain, current flows from the source to the drain. It should be noted that a source and a drain of a transistor are not fixed. For example, a source and a drain may be changed according to an applied voltage. Therefore, the disclosure is not limited to a source and a drain of a transistor. In the following description, a source and a drain of a transistor will be referred to as a first electrode and a second electrode.

A gate signal may swing between a gate-on voltage and a gate-off voltage. A transistor is turned on in response to a gate-on voltage and is turned off in response to a gate-off voltage. In the case of an n-channel transistor, the gate-on voltage may be a gate high voltage VGH, and the gate-off voltage may be a gate low voltage VGL. In the case of a p-channel transistor, the gate-on voltage may be the gate low voltage VGL, and the gate-off voltage may be the gate high voltage VGH.

Hereinafter, various embodiments of the present disclosure will be described in detail with reference to the accompanying drawings.

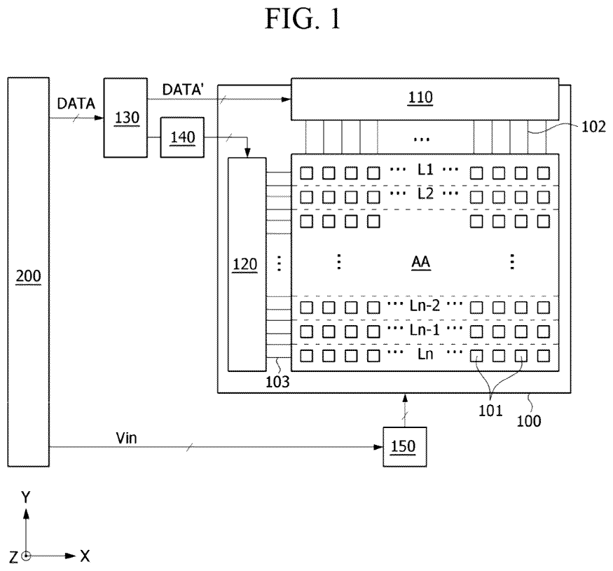

Referring to FIG. 1, a display device according to one embodiment of the present disclosure includes a display panel 100, a display panel driving circuit for writing pixel data to pixels 101 of the display panel 100, and a power supply 150 for generating power necessary for driving the pixels 101 and the display panel driving circuit.

A substrate of the display panel 100 may be, but is not limited to, a plastic substrate, a thin glass substrate, or a metal substrate. The display panel 100 may be, but is not limited to, a rectangular shaped panel having a length in the X-axis direction (or first direction), a width in the Y-axis direction (or second direction), and a thickness in the Z-axis direction (or third direction). For example, at least a portion of the display panel 100 may have a curved outer periphery.

The display panel 100 may be implemented as a non-transmissive display panel or a transmissive display panel. The transmissive display panel may be employed in a transparent display device in which an image is displayed on a screen and an actual object is visible beyond the display panel. The display panel 100 may be made as a flexible display panel. Additionally, the display panel 100 may be made of a stretchable panel that may be stretched.

A display area AA of the display panel 100 includes a pixel array for displaying an input image thereon. The pixel array includes a plurality of data lines 102, a plurality of gate lines 103 intersecting the data lines 102, and pixels 101 arranged in a matrix form. The display panel 100 may further include power lines commonly connected to the pixels 101. The power lines are commonly connected to the pixels and supply a constant voltage necessary for driving the pixels 101 to the pixels 101. The power lines may be implemented as long stripes of wires along either the first or second direction, or as mesh wires where the wires in the first direction and the wires in the second direction are electrically connected.

Each of the pixels 101 may be divided into a red sub-pixel, a green sub-pixel, and a blue sub-pixel for color implementation. Each of the pixels may further include a white sub-pixel. Each sub-pixel includes a pixel circuit for driving a light-emitting element. In the following, “pixel” may be interpreted as “subpixel.”

The pixel array includes a plurality of pixel lines L1 to Ln. Where n is a natural number greater than or equal to 2. Each of the pixel lines L1 to Ln may include a plurality of subpixels arranged along the X-axis direction in the pixel array of the display panel 100. The pixels arranged in one pixel line may share a gate line 103. The sub-pixels arranged along the Y-axis direction may share the same data line 102. One horizontal period is a time obtained by approximately dividing one frame period by the total number of the pixel lines L1 to Ln.

The power supply 150 generates the constant voltages (or direct current (DC) voltages) required for driving the pixel array and the display panel driving circuit of the display panel 100 using a DC-DC converter. The DC-DC converter may include a charge pump, a regulator, a buck converter, a boost converter, and the like. The power supply 150 may adjust the level of the input voltage Vin from a host system 200 to output constant voltages, such as a gamma reference voltage, a gate-low voltage, a gate-high voltage, a pixel driving voltage, a pixel ground voltage (hereinafter referred to as “ground voltage”), and the like. The gamma reference voltage is supplied to the data driver 110. The dynamic range of the data voltage output from the data driver 110 is determined by the voltage range of the gamma reference voltage. The dynamic range of the data voltage is the range of voltages between the maximum voltage and the minimum voltage of a data voltage.

The gate-high voltage and the gate-low voltage are supplied to a level shifter 140 and the gate driver 120. The constant voltages such as the pixel driving voltage and the ground voltage are supplied to the pixels 101 through the power lines commonly connected to the pixels 101. The pixel driving voltage may be supplied from a main power source of the host system 200 to the display panel 100. In this case, the power supply 150 does not need to output the pixel driving voltage.

The display panel driving circuit writes the pixel data of the input image to the pixels of the display panel 100 under the control of the timing controller 130. The display panel driving circuit includes the data driver 110, the gate driver 120, and a level shifter 140. The display panel driving circuit may further include a touch sensor driver for driving touch sensors. The touch sensor driver is omitted from FIG. 1. The data driver 110 and the touch sensor driver may be integrated into one drive IC (Integrated Circuit). The timing controller 130, the power supply 150, the level shifter 140, the data driver 110, the touch sensor driver may be further integrated into the drive ID.

The data driver 110 receives the pixel data DATA′ of the input image provided as a digital signal from the timing controller 130 and outputs data voltages of the pixel data. The data driver 110 outputs the data voltages by converting the pixel data DATA′ of the input image into gamma-compensated voltages using a digital-to-analog converter (hereinafter referred to as “DAC”) arranged in the data output channels. The gamma reference voltage is divided into the gamma-compensated voltages for each grayscale by a voltage divider circuit in the data driver 110 and supplied to the DAC. The DAC generates the data voltage as the gamma-compensated voltage corresponding to the grayscale value of the pixel data DATA'. The data voltage output from the DAC is output to the data line 102 through an output buffer in each of the data output channels of the data driver 110.

The gate driver 120 may be formed in the display panel 100 together with a TFT array of the pixel array and the wires. The gate driver 120 may be disposed in the non-display area NA outside the display area AA in the display panel 100, or at least a portion thereof may be disposed in the display area AA.

The gate driver 120 may be disposed in either a left non-display area NA or a right non-display area NA outside the display area AA in the display panel 100 to supply the gate signal to the gate lines 103 in a single feeding method. In the single feeding method, the gate signal is applied to one ends of the gate lines. The gate driver 120 may be disposed in the left non-display area NA and the right non-display area NA in the display panel 100 to apply the gate signal to the gate lines 103 in a double feeding method. In the double feeding method, the gate signal is applied simultaneously to both ends of the gate lines 103. At least some circuits of the gate driver 120 may be disposed within the display area AA. The gate driver 120 may include one or more shift registers and/or one or more edge triggers to output pulses of the gate signal under the control of the timing controller 130.

The gate signal may include a gate signal in the form of a square wave and a gate signal having a ramp waveform in which the voltage changes gradually with a constant slope. In this case, the display device may further include a ramp waveform generating circuit. The ramp waveform generating circuit may be mounted on a circuit board electrically connected to the display panel 100 such as a printed circuit board (PCB), or may be disposed on the display panel 100. The gate driver 120 may include the ramp waveform generating circuit to output a gate signal of a ramp waveform.

The timing controller 130 receives the pixel data of the input image and a timing signal synchronized with the pixel data from the host system 200. The timing signal may include a vertical synchronization signal Vsync, a horizontal synchronization signal Hsync, and a data enable signal DE. A vertical period and a horizontal period may be known by counting the data enable signal DE, and thus the vertical synchronization signal Vsync and the horizontal synchronization signal Hsync may be omitted. The data enable signal DE has an interval of one horizontal period (1 H).

The timing controller 130 may control the operation timings of the data driver 110 and the gate driver 120 based on the timing signals Vsync, Hsync, and DE received from the host system 200. The gate timing control signal output from the timing controller 130 may be input to the gate driver 120 through the level shifter 140. The level shifter 140 may receive the gate timing control signal and generate a start pulse and a clock signal to provide them to the gate driver 120. The input signal to the level shifter 140 is a signal of a digital signal voltage level. The start pulse and the clock signal output from the level shifter 140 may swing between the gate-high voltage and the gate-low voltage. A data timing control signal generated from the timing controller 130 is transmitted to the data driver 110.

The host system 200 may scale an image signal from a video source to match the resolution of the display panel 100, and may transmit it to the timing controller 130 together with the timing control signal.

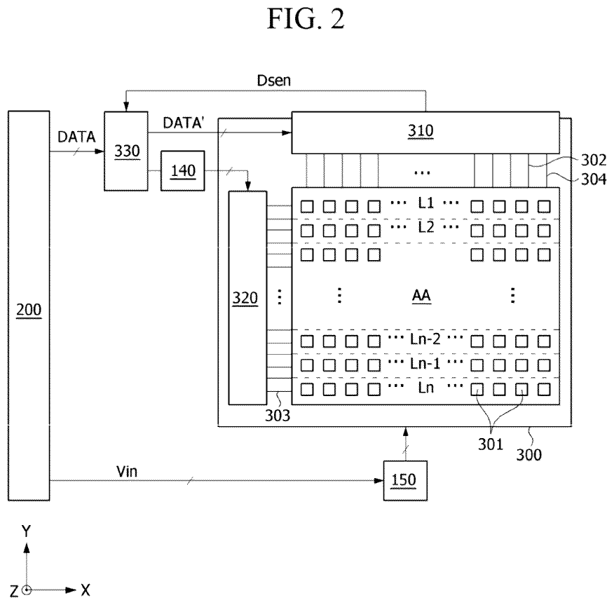

FIG. 2 is a block diagram illustrating a display device according to another embodiment of the present disclosure. In this embodiment, descriptions that are redundant to the forgoing embodiments is omitted.

Referring to FIG. 2, the display area AA of the display panel 100 includes a plurality of data lines 302, a plurality of gate lines 303 intersecting the data lines 302, a plurality of sensing lines 304, and pixels 301. The display panel 100 may further include power lines commonly connected to the pixels 301. The sensing lines 304 may be electrically connected to the transistors and/or light-emitting elements of the subpixels.

The display device may further include a sensing circuit 400. The sensing circuit provides digital data (hereinafter referred to as “sensing data”), corresponding to sensing voltages obtained from the subpixels, to the timing controller 330 using the data driver 310, the gate driver 320, and the sensing lines 304. The sensing circuit may be driven in sensing mode to output sensing data.

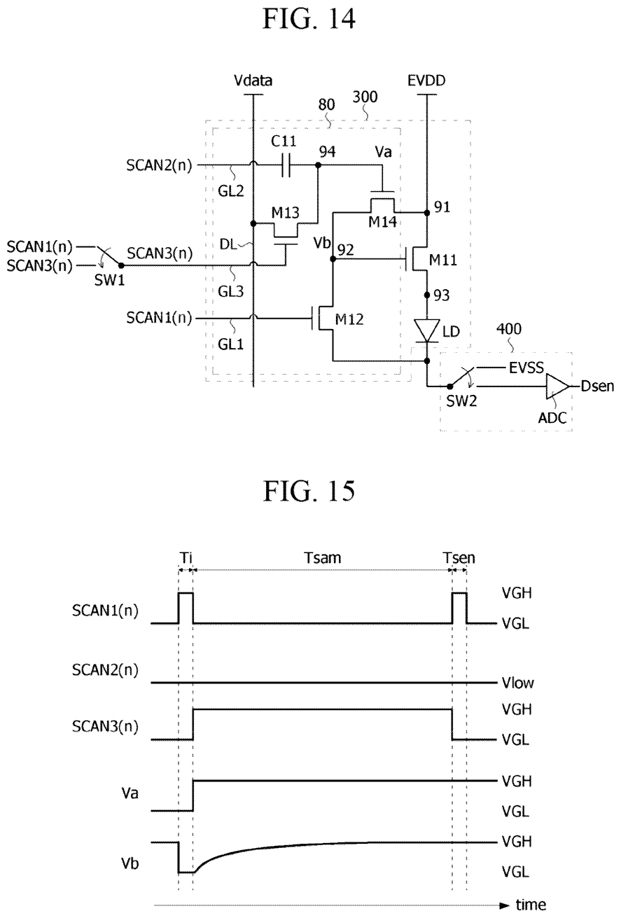

The data driver 310 may be connected to the data lines 302 and the sensing lines 304. The data driver 310 receives the pixel data DATA′ of the input image provided from the timing controller 330 and outputs the data voltage. The data driver 310 includes data channels that are electrically connected to the data lines 302 and that output the data voltages, and sensing channels that are electrically connected to the sensing lines 304 and that receive the sensing voltages. The data output channels convert the pixel data DATA′ of the input image into gamma-compensated voltages using the DAC and output the data voltages of the pixel data. The sensing channels include an analog-to-digital converter (hereinafter referred to as “ADC”). The sensing channels convert the sensing voltages received through the sensing lines 304 into digital data by using the ADC and output sensing data Dsen. The sensing lines 304 may be connected to the cathode electrode of the light-emitting element LD, as shown in FIG. 14. The sensing data Dsen is sent to the timing controller 330.

Each of the sub-pixels includes a transistor for driving the light-emitting element. Transistors should have uniform electrical characteristics across all sub-pixels, but there may be variations in electrical characteristics between pixels due to process variation and device characteristic variation. In addition, the transistors may be deteriorated as the driving time thereof elapses. Deterioration of the transistors may lead to degraded image quality and a shortened lifespan. The external compensation circuit may compensate for changes in the electrical characteristics of each sub-pixel in real time by sensing the electrical characteristics of the transistor in real time and reflecting the sensing results to modulate the pixel data of the input image.

The display panel driving circuit writes the pixel data of the input image into the pixels 301 by scanning the pixels in the display mode under the control of the timing controller 330. In the display mode, the input image is reproduced on the display area AA. The sensing circuitry may be driven in the sensing mode to sequentially sense the electrical characteristics of subpixels in the display area AA, such as a threshold voltage of the transistor.

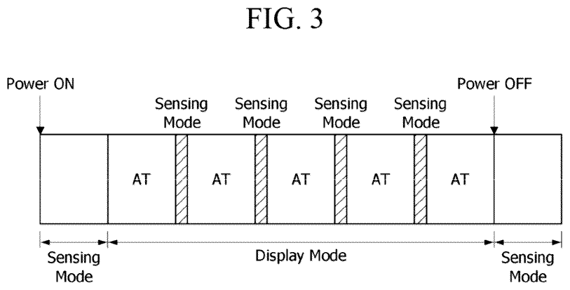

As shown in FIG. 3, the display panel driving circuit may enter the sensing mode in at least one of a power ON sequence in which power is started to be applied to the display device, a vertical blank period (hereinafter, referred to as a “blank period”) within a display time, and a power OFF sequence in which a power-off switch of the display device is turned on.

While the pixels 301 of the display panel 100 are driven, the electrical characteristics of the sub-pixels may be sensed in real time. For example, in a blank period with no pixel data of an input image between an (N)th frame period (N is a natural number) and an (N+1)th frame period, the display panel driving circuit may enter the real-time sensing mode to sense the sub-pixels of a selected pixel line under the control of the timing controller 330. In FIG. 3, the shaded portion between the frame periods represents the blank period. One frame period may include an active period AT and a vertical blank period, as shown in FIG. 3. The (N)th frame data may be written to the pixels 301 of the display panel 100 during the active period AT of the (N)th frame period, and the (N+1)th frame data may be written to the pixels 301 of the display panel 300 during the active period AT of the (N+1)th frame period.

Due to the short blank period, it is not possible to sense the electrical characteristics of each subpixels in all pixel line of the display panel 300. In this case, in the real-time sensing mode, subpixels of a selected pixel line may be sensed during a blank period of the (N)th frame period under the control of the timing controller 330, and subpixels of another selected pixel line may be sensed during the blank period of (N+1)th frame period under the control of the timing controller 330.

The timing controller 330 may receive the sensing data Dsen from the sensing channel of the data driver 310, and may derive a compensation value for compensating for the amount of threshold voltage shift of the transistor in each of the subpixels based on the sensing data Dsen. The compensation value may be pre-stored in a look-up table memory that is accessed by the timing controller 330. Threshold voltage data stored in the look-up table memory may be stored for each sub-pixel. The look-up table memory may output a compensation value for the threshold voltage Vth stored at an address indicated by the sensing data Dsen when the sensing data Dsen is inputted. The timing controller 330 may update the threshold voltage data stored in the look-up table memory with the sensing data Dsen received from the ADC.

The timing controller 330 may modulate the pixel data DATA of the input image by adding or multiplying the compensation value derived based on the sensing data Dsen to the pixel data DATA. The modulated pixel data DATA′ has a grayscale value modulated by the amount of the threshold voltage shift of the transistor DR. The modulated pixel data DATA′ from the timing controller 330 is transmitted to the data driver 310 during the active period AT in the display mode, where it is converted into the data voltages and written to the sub-pixels.

The data driver 310 converts the modulated pixel data DATA′ received from the timing controller 330 during the active period AT every frame period in the display mode into the data voltages Vdata and outputs the converted data voltages Vdata. The data driver 310 may output sensing data voltages in the sensing mode. The sensing data voltages may be applied to the subpixels through the data lines 302, similarly to the data voltages of the pixel data. The sensing data voltages may be output by the data driver 310 after the sensing data generated by the timing controller 330 in sensing mode is converted into a gamma compensation voltage, but is not limited thereto. The sensing data voltage may be set to a voltage lower than the threshold voltage of the light-emitting element to enable sensing of the threshold voltage of the transistor driving the light-emitting element while preventing the light-emitting element from emitting light.

The gate driver 320 may output a gate signal synchronized with the data voltage corresponding to the pixel data to the gate lines 303 during the active period AT every frame period, and in the sensing mode, it may output a gate signal synchronized with the sensing data voltage to the gate lines 303. The gate signals may include a ramp signal. The gate driver 320 may include a ramp signal generating circuit to output the ramp signal.

In case where a plurality of gate signals are applied to each of the pixels, the gate drivers 120 and 320 may include a plurality of gate drivers.

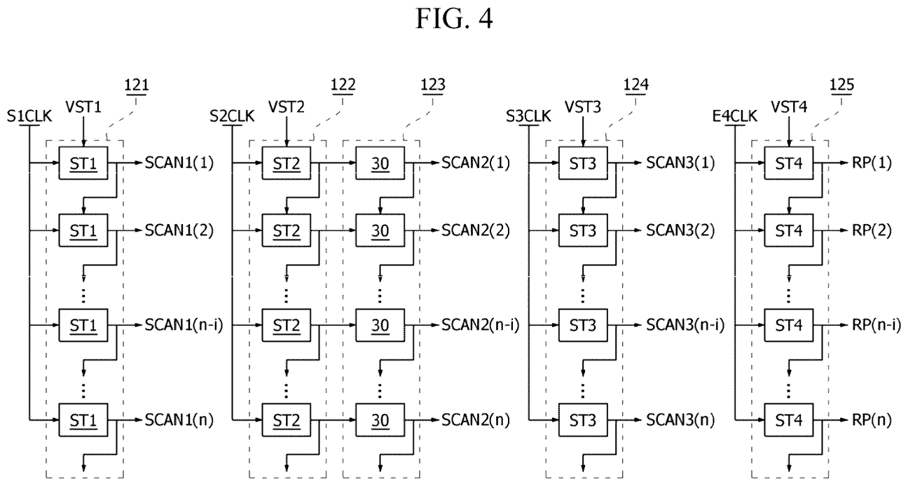

FIG. 4 is a diagram showing an example of a gate driver shown in FIGS. 1 and 2. In (n-i) shown in FIG. 4, i is a positive integer smaller than n. SCAN1(x) is a first gate signal applied to subpixels of a (x)th (where x is a positive integer less than or equal to n) pixel line. SCAN2(x) is a second gate signal applied to subpixels of a (x)th pixel line.

Referring to FIG. 4, a gate driver 120 may include a first gate driver 121 configured to output pulses of first gate signals SCAN1(1) to SCAN1(n), a second gate driver 122 configured to output second gate signals SCAN2(1) to SCAN2(n), and a ramp waveform generator 123.

A shift register of the first gate driver 121 may include a plurality of signal transmitters ST1 connected in cascade. The first gate driver 121 sequentially outputs pulses of first gate signals SCAN1(1) to SCAN1(n) by receiving a first start signal VST1 and a first clock S1CLK.

A shift register of the second gate driver 122 includes a plurality of signal transmitters ST2 connected in cascade. The second gate driver 122 sequentially outputs pulses of second gate signals SCAN2(1) to SCAN2(n) by receiving a second start signal VST2 and a second clock S2CLK.

The signal transmitters ST2 of the second gate driver 122 sequentially output pulses of second gate signals SCAN2(1) to SCAN2(n), and a ramp waveform generator 123 may receive the pulses of the second gate signals SCAN2(1) to SCAN2(n) input from the second gate driver 122 and convert the pulses of the second gate signals SCAN2(1) to SCAN2(n) into signals of a ramp waveform.

The ramp waveform generator 123 may include a plurality of ramp signal output parts 30 respectively connected to the signal transmitters ST2 of the second gate driver 122. Each of the ramp signal output parts 30 converts a pulse input from a corresponding signal transmitter ST2 into a signal of a ramp waveform.

The gate driver 120 may further include a third gate driver 124 configured to output pulses of third gate signals SCAN3(1) to SCAN3(n). A shift register of the third gate driver 124 includes a plurality of signal transmitters ST3 connected in cascade. The third gate driver 124 sequentially outputs pulses of third gate signals SCAN3(1) to SCAN3(n) by receiving a third start signal VST3 and a third clock S3CLK.

The gate driver 120 may further include a fourth gate driver 125 configured to output pulses of fourth gate signals RP(1) to RP(n). A shift register or edge trigger of the fourth gate driver 125 includes a plurality of signal transmitters ST4 connected in cascade. The fourth gate driver 125 sequentially outputs pulses of fourth gate signals RP(1) to RP(n) by receiving a fourth start signal VST4 and a fourth clock E4CLK.

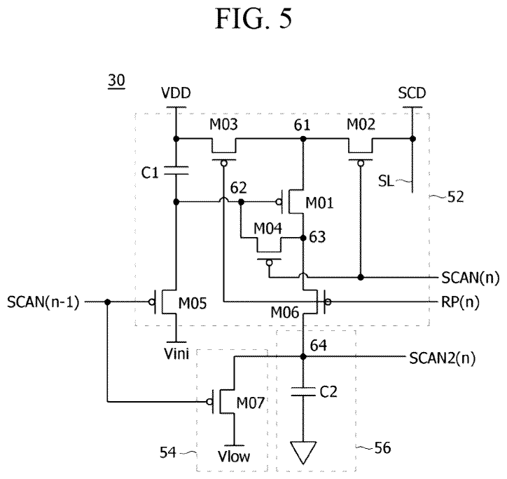

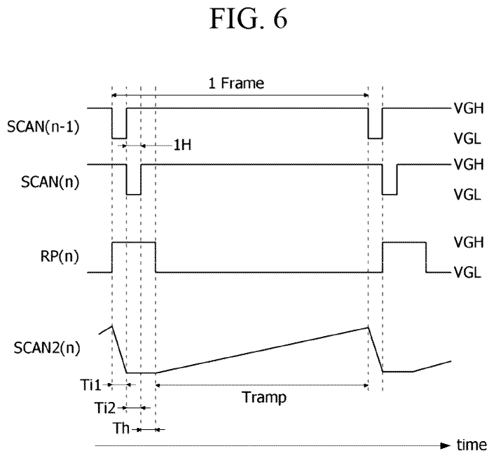

FIG. 5 is a circuit diagram showing a ramp signal output part according to an embodiment of the present disclosure. FIG. 6 is a waveform diagram showing an example of input and output signals of the ramp signal output part shown in FIG. 5. In FIG. 6, “VGL” represents a gate low voltage, and “VGH”represents a gate high voltage. “1 frame”indicates a 1-frame period.

Referring to FIGS. 5 and 6, a ramp signal output part 30 includes a current generator 52, a ramp waveform controller 54, and a charger 56. The current generator 52 generates a current by receiving input signals SCAN(n−1) to SCAN(n), and RP(n). The ramp waveform controller 54 controls a ramp waveform by initializing the charger 56 and adjusting an amount of charge accumulated in the charger 56. The charger 56 charges a charge from the current generator 52.

The ramp signal output part 30 receives first to third input signals SCAN(n−1), SCAN(n), and RP(n) and outputs a second gate signal SCAN2(n) of a ramp waveform. The first and second input signals SCAN(n−1) and SCAN(n) may be (n−1)th and (n)th pulses sequentially output from the second gate driver 122. The third input signal RP(n) may be a pulse output from the fourth gate driver 125.

Pulses of the first and second input signals SCAN(n−1) to SCAN(n) may be generated with a gate low voltage (VGL) and may have a pulse width of approximately one horizontal period (1 H), as shown in FIG. 6. A pulse of the third input signal RP(n) may be generated with a gate high voltage (VGH) and may have a pulse width of approximately three horizontal periods so as to overlap with pulses of the first and second input signals SCAN(n−1) to SCAN(n), as shown in FIG. 6.

The ramp signal output part 30 may receive a slope data voltage SCD. The slope data voltage SCD may be output from a data driver 110 under control of a timing controller 130 or may be output from the power supply 150. The slope data voltage SCD may be generated with the same data value during one frame period. Accordingly, the slope data voltage SCD may be commonly input to all the ramp signal output parts 30 formed on a display panel 100 through one wiring formed on the display panel 100.

The timing controller 130 or a host system 200 may change a slope of a second gate signal SCAN2(n) by changing a voltage level of a slope data voltage SCD.

The current generator 52 may include first to sixth transistors M01 to M06 and a first capacitor C1. The ramp waveform controller 54 includes a seventh transistor M07. The charger 56 may include a second capacitor C2. The transistors M01 to M07 may be implemented as p-channel transistors, but are not limited thereto.

A first transistor M01 is connected between a first node 61 to which a driving voltage VDD is applied and a third node 63, and generates a current according to a gate-source voltage. A first capacitor C1 charges the gate-source voltage of the first transistor M01. The first transistor M01 includes a first electrode connected to the first node 61, a gate electrode connected to a second node 62, and a second electrode connected to the third node 63. The first capacitor C1 is connected between a VDD node to which the driving voltage VDD is applied and the second node 62.

A second transistor M02 is connected between a slope data line SL to which a slope data voltage SCD is applied and the first node 61, and is turned on in response to a gate low voltage VGL of a second input signal SCAN(n). When the second transistor M02 is turned on, the slope data line SL may be applied to the first node 61. The second transistor M02 includes a first electrode to which the slope data voltage SCD is applied, a gate electrode to which the second input signal SCAN(n) is applied, and a second electrode connected to the first node 61.

A third transistor M03 is connected between a VDD node and the first node 61 and is turned on in response to a gate low voltage VGL of a third input signal RP(n). When the third transistor M03 is turned on, the VDD node is electrically connected to the first node 61. The third transistor M03 includes a first electrode connected to the VDD node, a gate electrode to which the third input signal RP(n) is applied, and a second electrode connected to the first node 61.

A fourth transistor M04 is connected between a second node 62 and a third node 63 and is turned on in response to a gate low voltage VGL of a second input signal SCAN(n). When the fourth transistor M04 is turned on, the second node 62 is electrically connected to the third node 63. The fourth transistor M04 includes a first electrode connected to the second node 62, a gate electrode to which the second input signal SCAN(n) is applied, and a second electrode connected to the third node 63.

A fifth transistor M05 is connected between the second node 62 and an initialization voltage node to which an initialization voltage Vini is applied, and is turned on in response to a gate low voltage VGL of a first input signal SCAN(n−1). When the fifth transistor M05 is turned on, the second node 62 is electrically connected to the initialization voltage node. The fifth transistor M05 includes a first electrode connected to the second node 62, a gate electrode to which the first input signal SCAN(n−1) is applied, and a second electrode connected to an initialization voltage node.

A sixth transistor M06 is connected between the third node 63 and a fourth node 64 and is turned on in response to a gate low voltage VGL of a third input signal RP(n). When the sixth transistor M06 is turned on, the third node 63 is electrically connected to the fourth node 64. The sixth transistor M06 includes a first electrode connected to the third node 63, a gate electrode to which the third input signal RP(n) is applied, and a second electrode connected to the fourth node 64.

A seventh transistor M07 is connected between the fourth node 64 and a reference voltage node (or a ground voltage node) to which a reference voltage Vlow is applied, and is turned on in response to a gate low voltage VGL of a first input signal SCAN(n−1). A voltage of the fourth node 64 is a voltage of a second gate signal SCAN2(n). The fourth node 64 is connected to pixel circuits of pixels 101 through a gate line. When the seventh transistor M07 is turned on, a reference voltage node is electrically connected to the fourth node 64, and a reference voltage Vlow is applied to the fourth node 64. The seventh transistor M07 includes a first electrode connected to the fourth node 64, a gate electrode to which a first input signal (SCAN(n−1)) is applied, and a second electrode connected to the reference voltage node (or the ground voltage node).

A second capacitor C2 may be connected between the fourth node 64 and the reference voltage node (or the ground voltage node).

A driving period of the ramp signal output part 30 may be divided into a first period Ti1, a second period Ti2, and a third period Tramp. A hold period Th, during which second to seventh transistors M02 to M07 are in an off-state, may be set between the second period Ti2 and the third period Tramp.

After a pulse of a first input signal SCAN(n−1) is generated during the first period Ti1, a pulse of a second input signal SCAN(n) is generated during the second period Ti2. A pulse of a third input signal RP(n) is generated with a gate high voltage VGH during two or three horizontal periods including the first period Ti1 and the second period Ti2. The pulse of the third input signal RP(n) overlaps with the pulses of the first and second input signals SCAN(n−1) and SCAN(n).

During the first period Ti1, a voltage of the first input signal SCAN(n−1) is a gate low voltage VGL, and voltages of the second input signal SCAN(n) and the third input signal RP(n) are gate high voltages VGH. Accordingly, during the first period Ti1, the fifth and seventh transistors M05 and M07 are turned on, whereas the second, third, fourth, and sixth transistors M02, M03, M04, and M06 are turned off.

During the first period Ti1, the second node 62 is initialized to an initialization voltage Vini, and the fourth node 64 is initialized to a reference voltage Vlow. Accordingly, during the first period Ti1, a voltage of the second node 62 decreases to the initialization voltage Vini, and a voltage of the second gate signal SCAN2(n) decreases to the reference voltage Vlow.

During the second period Ti2, voltages of the first input signal SCAN(n−1) and the third input signal RP(n) are gate high voltages VGH, and a voltage of the second input signal SCAN(n) is a gate low voltage VGL. Accordingly, during the second period Ti2, the second and fourth transistors M02 and M04 are turned on, whereas the third, fifth, sixth, and seventh transistors M03, M05, M06, and M07 are turned off.

During the hold period Th, voltages of the input signals SCAN(n−1), SCAN(n), and RP(n) are gate high voltages VGH. Accordingly, during the hold period Th, the second to seventh transistors M02 to M07 are turned off, and voltages of the first to fourth nodes 61 to 64 are maintained at voltages at the end of the second period Ti2.

During the second period Ti2, the slope data voltage SCD is applied to the second node 62 through the first node 61, a channel of the first transistor M01, the third node 63, and a channel of the fourth transistor M04. In the second period Ti2, a voltage of the second node 62 becomes a slope data voltage compensated by a threshold voltage Vth of the first transistor M01, that is, SCD-Vth. Accordingly, at the end of the second period Ti2, a voltage of the first capacitor C1 becomes VDD-(SCD-Vth).

During the first period Ti1, the second period Ti2, and the hold period Th, the first transistor M01 is turned on, and a current may flow through the first transistor M01; however, the current is blocked by the sixth transistor M06, which is in an off-state, so that a charge is not accumulated in the second capacitor C2. During the second period Ti2 and the hold period Th, since the sixth transistor M06 is in an off-state, the fourth node 64 is floated, and a voltage of the second gate signal SCAN2(n) is maintained at a reference voltage Vlow.

During the third period Tramp, voltages of the first and second input signals SCAN(n−1) and SCAN(n) are gate high voltages VGH, and a voltage of the third input signal RP(n) is a gate low voltage VGL. Accordingly, during the third period Tramp, the third and sixth transistors M03 and M06 are turned on, whereas the second, fourth, fifth, and seventh transistors M02, M04, M05, and M07 are turned off.

During the third period Tramp, the second capacitor C2 is charged by a constant current from the first transistor M01, and a voltage of the fourth node 64 increases. Accordingly, during the third period Tramp, a voltage of the second gate signal SCAN2(n) applied to the pixel circuit may linearly increase as time elapses.

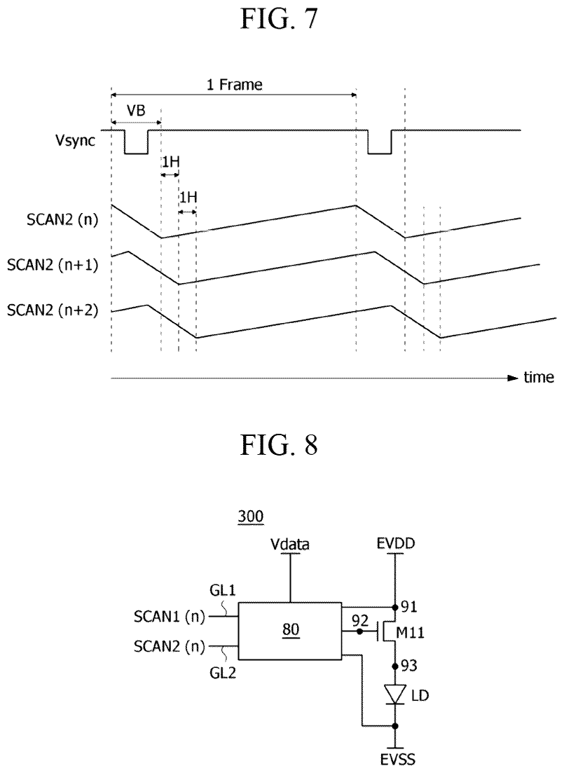

When pulses of input signals are sequentially input to the ramp waveform generator 123 in units of one horizontal period 1 H, pulses of the second gate signals SCAN2(n) to SCAN2(n+2) may be sequentially shifted by one horizontal period, as shown in FIG. 7. In FIG. 7, “Vsync” represents a vertical synchronization signal, and “VB”represents a blank period.

FIG. 8 is a circuit diagram showing a pixel circuit according to another embodiment of the present disclosure.

Referring to FIG. 8, a pixel circuit 300 includes a light-emitting element LD, a first transistor M11 configured to drive the light-emitting element LD, and a PWM driver 80 configured to drive the first transistor M11.

The light-emitting element LD may be implemented as an inorganic light-emitting element such as a micro light-emitting diode (micro LED) or as an organic light-emitting diode (OLED), and the inorganic light-emitting element and the organic light-emitting diode each include an anode electrode and a cathode electrode. The anode electrode of the light-emitting element LD may be connected to a third node 93, and the cathode electrode may be connected to a power line to which a ground voltage EVSS is applied. The light-emitting element may be driven and emit light by a current from the first transistor M11.

The OLED includes an anode electrode, a cathode electrode, and an organic compound layer interposed between the electrodes. The organic compound layer may include a hole injection layer (HIL), a hole transport layer (HTL), a light emission layer (EML), an electron transport layer (ETL), and an electron injection layer (EIL), but is not limited thereto. When a voltage is applied to the anode electrode and the cathode electrode of the light-emitting element LD, holes passing through the hole transport layer HTL and electrons passing through the electron transport layer ETL move to the light emission layer EML, thereby forming excitons. At this time, visible light is emitted from the light emission layer EML. The OLED may be implemented as a tandem structure OLED in which a plurality of light emission layers are stacked. The tandem structure OLED may improve luminance and lifetime of a pixel.

The inorganic light-emitting element may be implemented as a micro LED chip having a vertical structure in which electrodes are arranged on an upper and a lower surface of a chip in which a light-emitting element is integrated, or as a lateral structure or a flip chip structure.

The first transistor M11 and the light-emitting element LD may be connected in series between a pixel driving voltage EVDD and a ground voltage EVSS. In FIG. 8, the light-emitting element LD is connected between the first transistor M11 and the ground voltage EVSS, but is not limited thereto. The light-emitting element LD may be connected between the pixel driving voltage EVDD and the first transistor M11.

The first transistor M11 controls a current flowing through a drain-source channel according to a gate-source voltage. The gate-source voltage of the first transistor M11 is varied according to a data voltage Vdata of pixel data applied to a gate electrode of the first transistor M11. The first transistor M11 includes a first electrode connected to the first node 91, a gate electrode connected to a second node 92, and a second electrode connected to the third node 93. A first power line to which a pixel driving voltage EVDD is applied is connected to a first node 91. The pixel driving voltage EVDD is applied to the first node 91. The first and second nodes 91 and 92 are connected to the PWM driver 80. A third node 93 is connected to an anode electrode of the light-emitting element LD. A second electrode of the first transistor M11 and a cathode electrode of the light-emitting element LD are connected to a second power line to which a ground voltage EVSS is applied.

The PWM driver 80 is connected to the data line to which a data voltage Vdata of pixel data is applied, a first gate line GL1 to which a first gate signal SCAN1(n) is applied, a second gate line GL2 to which a second gate signal SCAN2(n) is applied, the first node 91, the second node 92, and the second power line to which the ground voltage EVSS is applied. In the case of the pixel circuit shown in FIG. 14, the PWM driver 80 may be connected to a third gate line in a sensing mode.

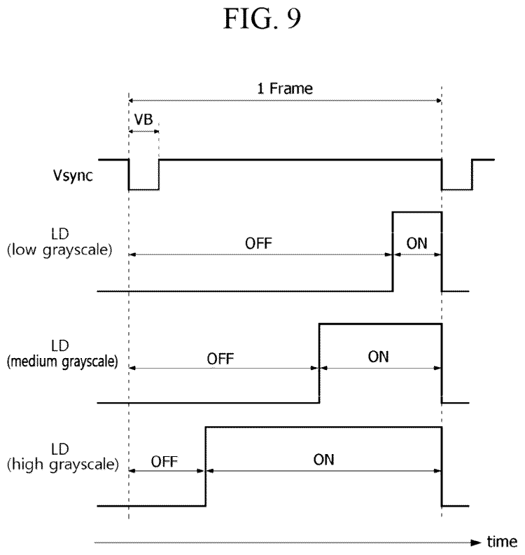

The PWM driver 80 adjusts a lighting period of the light-emitting element LD in response to a grayscale value of pixel data by receiving a data voltage Vdata of the pixel data, a first gate signal SCAN1(n), and a second gate signal SCAN2(n). When the grayscale value of the pixel data increases, the data voltage Vdata may increase. In this case, the PWM driver 80, as shown in FIG. 9, may increase the luminance of a sub-pixel when the grayscale of pixel data is high by extending the emission duration of the light-emitting element (LD) in proportion to the grayscale value of the pixel data. In FIG. 9, “ON” represents a lighting period of the light-emitting element LD, and “OFF”represents a non-lighting period of the light-emitting element LD.

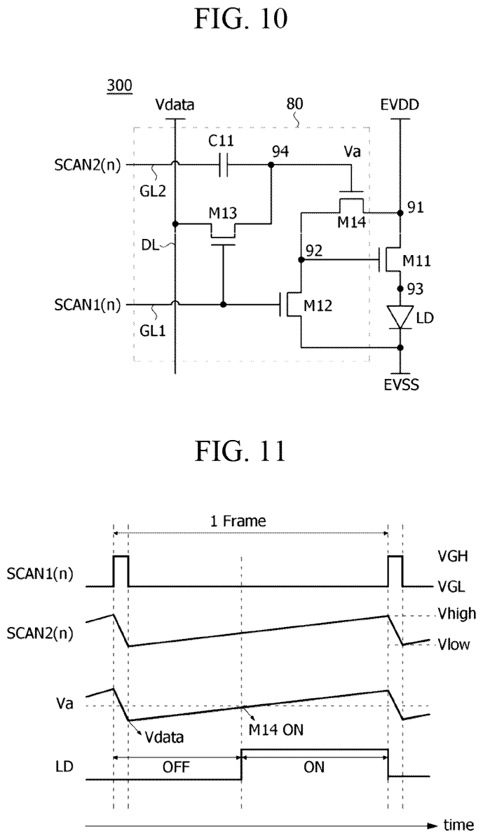

FIG. 10 is a circuit diagram showing in detail an example of the pixel circuit shown in FIG. 8. In FIG. 10, redundant descriptions overlapping with the above-described embodiment in connection with FIG. 8 are omitted. FIG. 11 is a waveform diagram showing an example of input and output signals of the pixel circuit shown in FIG. 10 in a display mode.

Referring to FIGS. 10 and 11, the pixel circuit 300 includes a light-emitting element LD, a first transistor M11 configured to drive the light-emitting element LD, and a PWM driver 80 configured to drive the first transistor M11. The PWM driver 80 includes second to fourth transistors M12, M13, and M14, and a capacitor C11. In this pixel circuit, the transistors M11 to M14 may be implemented as n-channel transistors, but are not limited thereto.

The pixel circuit 300 drives the light-emitting element LD by receiving a pixel driving voltage EVDD, a ground voltage EVSS, a data voltage Vdata, a first gate signal SCAN1(n), and a second gate signal SCAN2(n). The light-emitting element LD may emit light during a lighting period corresponding to a grayscale value of pixel data in a display mode.

The data voltage Vdata of the pixel data may vary depending on the grayscale value of the pixel data. For example, in a dynamic range of 0 V to 8.5 V, the data voltage Vdata may be a maximum voltage of 8.5 V when the grayscale value of the pixel data is a maximum grayscale (or a white grayscale), while the data voltage may be a minimum voltage of 0 V when the grayscale value of the pixel data is a minimum grayscale (or a black grayscale). The pixel driving voltage EVDD may be a constant voltage higher than the maximum voltage of the data voltage Vdata, for example, 10 V. The ground voltage EVSS may be a constant voltage equal to or lower than the minimum voltage of the data voltage Vdata, for example, 0 V.

The first gate signal SCAN1(n) includes pulses that swing between a gate high voltage VGH and a gate low voltage VGL in every frame period in a display mode. The gate high voltage VGH of the first gate signal SCAN1(n) may be a constant voltage higher than the pixel driving voltage EVDD, for example, 30 V. The gate low voltage VGL of the first gate signal SCAN1(n) may be a constant voltage lower than the ground voltage EVSS, for example, −25 V.

The second gate signal SCAN2(n) is generated as a ramp waveform signal that increases from a minimum voltage to a maximum voltage in every frame period in the display mode. A voltage of the second gate signal SCAN2(n) gradually increases from a reference voltage Vlow, that is, the minimum voltage, to a maximum voltage Vhigh during one frame period in the display mode. The reference voltage Vlow may be set to a voltage such as the ground voltage EVSS or the gate low voltage VGL, but is not limited thereto. The maximum voltage Vhigh may be adjusted by a slope data voltage SCD. The maximum voltage Vhigh of the second gate signal SCAN2(n) may be lower than the gate high voltage VGH and higher than the pixel driving voltage EVDD, for example, 20 V. The reference voltage Vlow of the second gate signal SCAN2(n) may be lower than the ground voltage EVSS and higher than the gate low voltage VGL, for example, −20 V.

The first transistor M11 includes a first electrode connected to the first node 91, a gate electrode connected to a second node 92, and a second electrode connected to the third node 93. A first power line to which a pixel driving voltage EVDD is applied may be connected to a first node 91. The light-emitting element LD includes an anode electrode connected to a third node 93 and a cathode electrode connected to a second power line to which a ground voltage EVSS is applied. A capacitor C11 is disposed between a fourth node 94 and a second gate line GL2. A second gate signal SCAN2(n) is applied to the second gate line GL2.

A second transistor M12 is turned on in response to a gate high voltage VGH of a first gate signal SCAN1(n). When the second transistor M12 is turned on, a second node 92 may be electrically connected to a second power line to which a ground voltage EVSS is applied. The second transistor M12 includes a first electrode connected to the second node 92, a gate electrode connected to a first gate line GL1 to which the first gate signal SCAN1(n) is applied, and a second electrode connected to the second power line.

A third transistor M13 is connected between a fourth node 94 and a data line DL and is turned on in response to a gate high voltage VGH of the first gate signal SCAN1(n). When the third transistor M13 is turned on, the fourth node 94 is electrically connected to the data line DL to which a data voltage Vdata is applied. The third transistor M13 includes a first electrode connected to the data line DL, a gate electrode connected to the first gate line GL1, and a second electrode connected to the fourth node 94.

A fourth transistor M14 is connected between a first node 91 and a second node 92 and is turned on when a voltage of the fourth node 94 is higher than its threshold voltage. When the fourth transistor M14 is turned on, a gate voltage of the first transistor M11 increases and the first transistor M11 is turned on, so that a current flows through the first transistor M11 to the light-emitting element LD, and the light-emitting element LD may emit light. When the fourth transistor M14 is turned on, the light-emitting element LD starts emitting light. The earlier the fourth transistor M14 is turned on, the longer the lighting period (ON) of the light-emitting element LD becomes. The fourth transistor M14 includes a first electrode connected to the second node 92, a gate electrode connected to the fourth node 94, and a second electrode connected to the first node 91.

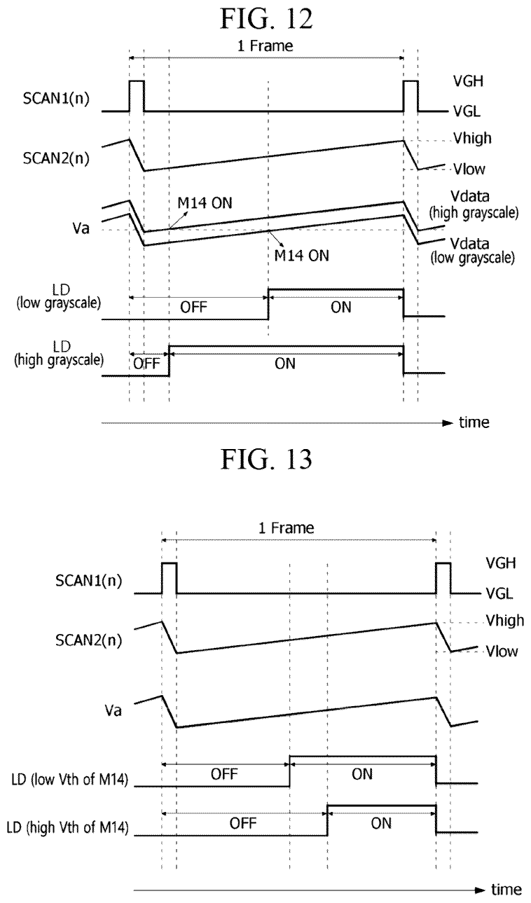

When the third transistor M13 is turned on, a data voltage Vdata is applied to the fourth node 94, and a voltage Va of the fourth node 94 becomes equal to the data voltage Vdata. The voltage Va of the fourth node 94 gradually increases from the data voltage Vdata during one frame period by a voltage of the second gate signal SCAN2(n) applied through capacitor coupling. As shown in FIG. 12, the higher the grayscale value of the pixel data is, the higher the data voltage Vdata becomes, and the earlier the fourth transistor M14 is turned on. On the other hand, the lower the grayscale value of the pixel data is, the lower the data voltage Vdata becomes, and the later the fourth transistor M14 is turned on. As a result, the lighting period (ON) of the light-emitting element LD becomes longer at high grayscale, whereas the lighting period (ON) of the light-emitting element LD becomes shorter at low grayscale.

A transistor that affects the lighting period of the light-emitting element LD, for example, the fourth transistor M14, may experience a shift in its threshold voltage due to variation among subpixels or due to accumulated stress over driving time. In this case, the lighting period of the light-emitting element LD may vary even for pixel data having the same grayscale value. A turn-on voltage of the fourth transistor M14 is Vgs-Vth, where Vgs is a gate-to-source voltage of the transistor, and Vth is a threshold voltage of the transistor.

As shown in FIG. 13, when a threshold voltage of the fourth transistor M14 is small, the fourth transistor M14 is turned on earlier, so the lighting period of the light-emitting element LD becomes longer. In contrast, even if a voltage Va of the fourth node 94 is the same, when the threshold voltage of the fourth transistor M14 becomes larger, the fourth transistor M14 is turned on later, and the lighting period of the light-emitting element LD becomes shorter. As a result, even with the same grayscale value, lighting periods may differ among subpixels, and the longer the driving time becomes, the shorter the lighting period of the subpixels may become.

In the pixel circuit shown in FIG. 10, the first transistor M11 operates as a diode when the fourth transistor M14 is turned on. Since the current flowing through a channel of the first transistor M11 in the on-state operates at the boundary between a linear region and a saturation region, an influence of threshold voltage variation is small, and a need for threshold voltage variation compensation is low. Accordingly, in the pixel circuit shown in FIG. 10, sensing a threshold voltage of the fourth transistor M14 and compensating in real time for a variation or deviation in the sensed threshold voltage of the fourth transistor M14 is effective in improving image quality and extending the lifetime of the display device. To achieve this, as shown in FIG. 14, a sensing circuit may be connected to the pixel circuit.

FIG. 14 is a circuit diagram showing a pixel circuit according to another embodiment of the present disclosure. FIG. 15 is a waveform diagram showing gate signals applied to the pixel circuit shown in FIG. 14 in a sensing mode. In this embodiment, identical reference numerals are assigned to components that are substantially the same as those of the pixel circuit shown in FIG. 10, and redundant descriptions thereof are omitted.

Referring to FIGS. 14 and 15, a sensing circuit 400 is connected to the pixel circuit 300.

In a sensing mode, the pixel circuit 300 receives a pixel driving voltage EVDD, a ground voltage EVSS, a data voltage Vdata, a first gate signal SCAN1(n), a second gate signal SCAN2(n), and a third gate signal SCAN3(n). The gate driver 320 shown in FIG. 2 outputs gate signals SCAN1(n), SCAN2(n), and SCAN3(n) in a sensing mode under the control of a timing controller 330, in waveforms as shown in FIG. 15.

Second to fourth transistors M12 to M14 of the pixel circuit 300 are turned on in response to a gate high voltage VGH of corresponding gate signals SCAN1(n), SCAN2(n), and SCAN3(n), and are turned off at a gate low voltage VGL. The first transistor M11 may be turned on when the fourth transistor M14 is turned on.

The sensing circuit 400 includes a second switch element SW2, which operates in the sensing mode, and an ADC. The sensing circuit 400 may be embedded in a driver IC together with a circuit of the data driver 310.

In a sensing mode, a driving period of the pixel circuit 300 and the sensing circuit 400 may be divided into an initialization period Ti, a sampling period Tsam, and a sensing period Tsen. A voltage of the first gate signal SCAN1(n) is a gate high voltage VGH during the initialization period Ti and the sensing period Tsen, and is a gate low voltage VGL during the sampling period Tsam. A voltage of the second gate signal SCAN2(n) is maintained at a reference voltage Vlow in the sensing mode. A voltage of the third gate signal SCAN3(n) is a gate low voltage VGL during the initialization period Ti and the sensing period Tsen, and is a gate high voltage VGH during the sampling period Tsam. The timing controller 330 may control the initialization period Ti, the sampling period Tsam, and the sensing period Tsen using the first and third gate signals SCAN1(n) and SCAN3(n) in the sensing mode.

During the initialization period Ti, the pixel circuit 300 is initialized. During the initialization period Ti, the second transistor M12 is controlled to be in an on-state, and the fourth transistor M14 is controlled to be in an off-state. During the sampling period Tsam, the fourth transistor M14 is controlled to be in an on-state, and the second transistor M12 is controlled to be in an off-state, so that a threshold voltage Vth of the fourth transistor M14 is sampled. During the sampling period Tsam, a voltage Vb of the second node 92 rises to Vdata-Vth, where Vdata is a sensing data voltage, and Vth is a threshold voltage of the fourth transistor M14.

During the sensing period Tsen, the fourth transistor M14 is controlled to be in an off-state, and the second transistor M12 is controlled to be in an on-state, so that a voltage Vb of the second node 92 is converted into digital data and a threshold voltage Vth of the fourth transistor M14 is sensed. An ADC of the sensing circuit 400 converts the voltage Vb of the second node 92, which is input through a second switch element SW2 that is turned on in the sensing mode, into digital data and outputs sensing data Dsen (see FIG. 2), which indicates the threshold voltage Vth of the fourth transistor M14. The timing controller 330 may add a compensation value corresponding to the sensing data Dsen to pixel data, modulate the pixel data, and transmit the modulated pixel data DATA′ to the data driver 310, so as to control the data driver 310 such that a data voltage Vdata increased by the threshold voltage Vth of the fourth transistor M14 is output from the data driver 310 in a display mode.

A first switch element SW1 may be connected to the pixel circuit 300. The first switch element SW1 may be implemented as a multiplexer controlled by a logic circuit of the timing controller 330 or the data driver 310, but is not limited thereto. The first switch element SW1 supplies a first gate signal SCAN1(n) to a gate electrode of the third transistor M13 in a display mode, while supplying a third gate signal SCAN3(n) to the gate electrode of the third transistor M13 in a sensing mode.

The second switch element SW2 may be implemented as a multiplexer controlled by a logic circuit of the timing controller 330 or the data driver 310, but is not limited thereto. In the display mode, the second switch element SW2 connects a second electrode of the second transistor M12 and a cathode electrode of the light-emitting element LD to a second power line to which a ground voltage EVSS is applied. In the sensing mode, the second switch element SW2 connects the second electrode of the second transistor M12 and the cathode electrode of the light-emitting element LD to an input terminal of the ADC.

By sensing a voltage Vb of the second node 92 through the cathode electrode of the light-emitting element LD, the second transistor M12 can be shared between the display mode and the sensing mode. In order to sense a voltage Vb of the second node 92 through an anode electrode of the light-emitting element LD, an additional transistor needs to be added. In addition, a method of sensing the voltage Vb of the second node 92 through a cathode electrode of the light-emitting element LD has an advantage in that, since a reverse bias voltage is applied to the light-emitting element LD in the sensing mode, the voltage Vb of the second node 92 is sensed while the light-emitting element LD is reliably turned off. As a result, noise is not added to the sensed value, and unintended light emission of the light-emitting element LD in the sensing mode can be prevented.

The second transistor M12 is turned on in the initialization period Ti and the sensing period Tsen in response to a gate high voltage VGH of the first gate signal SCAN1(n) in the sensing mode, and is in an off-state during the sampling period Tsam. The second transistor M12 includes a first electrode connected to the second node 92, a gate electrode connected to a first gate line GL1, and a second electrode connected to a second power line.

The third transistor M13 is turned on at the beginning of the sampling period Tsam in response to a gate high voltage VGH of the third gate signal SCAN3(n) in the sensing mode, and remains in an on-state during the sampling period Tsam, and is in an off-state in the initialization period Ti and the sensing period Tsen. The third transistor M13 includes a first electrode connected to a data line DL, a gate electrode connected to a third gate line GL3 to which a third gate signal SCAN3(n) is applied in the sensing mode, and a second electrode connected to a fourth node 94.

The fourth transistor M14 is turned on in the sensing mode when a voltage of the fourth node 94 rises to a sensing data voltage Vdata. During the sampling period Tsam, the sensing data voltage Vdata is applied to the fourth node 94 through the third transistor M13, and a voltage Va of the fourth node 94 rises to the sensing data voltage Vdata. The fourth transistor M14 includes a first electrode connected to the second node 92, a gate electrode connected to the fourth node 94, and a second electrode connected to the first node 91.

According to one or more embodiments of the present disclosure, the display device may be applied to mobile devices, video phones, smart watches, watch phones, wearable device, foldable device, rollable device, bendable device, flexible device, curved device, sliding device, variable device, electronic organizer, electronic books, portable multimedia players (PMPs), personal digital assistants (PDAs), MP3 players, mobile medical devices, desktop PCs, laptop PCs, netbook computers, workstations, navigations, vehicle navigations, vehicle display devices, vehicle devices, theater devices, theater display devices, televisions, wallpaper devices, signage devices, game devices, laptops, monitors, cameras, camcorders, and home appliances, etc. Additionally, the display apparatus according to one or more embodiments of the present disclosure may be applied to organic light emitting lighting devices or inorganic light emitting lighting devices.

The aspects to be achieved by the present disclosure, the means for achieving the aspects, and effects of the present disclosure described above do not specify essential features of the claims, and thus, the scope of the claims is not limited to the disclosure of the present disclosure.

Although the embodiments of the present disclosure have been described in more detail with reference to the accompanying drawings, the present disclosure is not limited thereto and may be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure. The scope of protection of the present disclosure should be construed based on the following claims, and all technical features within the scope of equivalents thereof should be construed as being included within the scope of the present disclosure.

What is claimed is:

1. A pixel circuit, comprising:
a first transistor including a first electrode connected to a first node, a gate electrode connected to a second node, and a second electrode connected to a third node;
a light-emitting element connected to the third node; and
a pulse width modulation (PWM) driver connected to the first transistor and configured to adjust a lighting time of the light-emitting element according to a data voltage of pixel data,
wherein a first power line configured to receive a pixel driving voltage is connected to the first node, and
wherein an anode electrode of the light-emitting element is connected to the third node, and a cathode electrode of the light-emitting element is connected to a second power line configured to receive a ground voltage lower than the pixel driving voltage in a display mode.

2. The pixel circuit according to claim 1, wherein the PWM driver is connected to a data line configured to receive the data voltage, a first gate line configured to receive a first gate signal, a second gate line configured to receive a second gate signal, the first node, the second node, and the second power line.

3. The pixel circuit according to claim 2, wherein the first gate signal includes pulses that swing between a gate high voltage and a gate low voltage in each frame period in the display mode,
wherein the second gate signal is generated as a ramp waveform signal that increases from a minimum voltage to a maximum voltage in each frame period in the display mode,
wherein the gate high voltage is higher than the pixel driving voltage, and the gate low voltage is lower than the ground voltage, and
wherein the maximum voltage of the ramp waveform signal is lower than the gate high voltage and higher than the pixel driving voltage, and the minimum voltage of the ramp waveform signal is lower than the ground voltage and higher than the gate low voltage.

4. The pixel circuit according to claim 1, wherein a lighting period of the light-emitting element becomes longer as the data voltage increases.

5. The pixel circuit according to claim 2, wherein the PWM driver includes:
a capacitor arranged between a fourth node and the second gate line;
a second transistor including a first electrode connected to the second node, a gate electrode connected to the first gate line, and a second electrode connected to the second power line;
a third transistor including a first electrode connected to the data line, a gate electrode connected to the first gate line, and a second electrode connected to the fourth node; and
a fourth transistor including a first electrode connected to the second node, a gate electrode connected to the fourth node, and a second electrode connected to the first node.

6. The pixel circuit according to claim 5, wherein the light-emitting element starts emitting light when the fourth transistor is turned on, and
wherein the earlier a turn-on timing of the fourth transistor is, the longer a lighting period of the light-emitting element becomes.

7. The pixel circuit according to claim 1, wherein the PWM driver is connected to a data line configured to receive the data voltage, a first gate line configured to receive a first gate signal, a second gate line configured to receive a second gate signal, a third gate line configured to receive a third gate signal, the first node, the second node, and the second power line.

8. The pixel circuit according to claim 7, further comprising:
a first switch element configured to supply the first gate signal to the third gate line in the display mode, and to supply the third gate signal to the third gate line in a sensing mode; and
a sensing circuit connected to the light-emitting element and configured to operate in the sensing mode.

9. The pixel circuit according to claim 8, wherein the sensing circuit includes:
an analog-to-digital converter; and
a second switch element configured to supply the ground voltage to a cathode electrode of the light-emitting element in the display mode and to connect the cathode electrode of the light-emitting element to an input terminal of the analog-to-digital converter in the sensing mode.

10. The pixel circuit according to claim 9, wherein the first gate signal is a gate high voltage during an initialization period and a sensing period in the sensing mode, and is a gate low voltage during a sampling period in the sensing mode, and
wherein in the sensing mode, a voltage of the second gate signal is maintained at a reference voltage during the initialization period, the sampling period, and the sensing period,
wherein in the sensing mode, a voltage of the third gate signal is the gate low voltage during the initialization period and the sensing period, and is the gate high voltage during the sampling period.

11. The pixel circuit according to claim 10, wherein the PWM driver includes:
a capacitor arranged between a fourth node and the second gate line;
a second transistor including a first electrode connected to the second node, a gate electrode connected to the first gate line, and a second electrode connected to the second power line;
a third transistor including a first electrode connected to the data line, a gate electrode configured to receive the third gate signal in the sensing mode, and a second electrode connected to the fourth node; and
a fourth transistor including a first electrode connected to the second node, a gate electrode connected to the fourth node, and a second electrode connected to the first node.

12. A display device, comprising:
a display panel in which a plurality of data lines, a plurality of gate lines, a plurality of power lines, and a plurality of subpixels are arranged;
a data driver connected to the data lines; and
a gate driver connected to the gate lines,
wherein each of the plurality of subpixels includes:
a first transistor including a first electrode connected to a first node, a gate electrode connected to a second node, and a second electrode connected to a third node;
a light-emitting element connected to the third node; and
a pulse width modulation (PWM) driver connected to the first transistor and configured to adjust a lighting time of the light-emitting element according to a data voltage of pixel data,
wherein a first power line configured to receive a pixel driving voltage is connected to the first node, and
wherein an anode electrode of the light-emitting element is connected to the third node, and a cathode electrode of the light-emitting element is connected to a second power line configured to receive a ground voltage lower than the pixel driving voltage in a display mode.

13. The display device according to claim 12, wherein the PWM driver is connected to a data line configured to receive the data voltage, a first gate line configured to receive a first gate signal, a second gate line configured to receive a second gate signal, the first node, the second node, and the second power line,
wherein the first gate signal includes pulses that swing between a gate high voltage and a gate low voltage in each frame period in the display mode,
wherein the second gate signal is generated as a ramp waveform signal that increases from a minimum voltage to a maximum voltage in each frame period in the display mode,
wherein the gate high voltage is higher than the pixel driving voltage, and the gate low voltage is lower than the ground voltage, and
wherein a maximum voltage of the ramp waveform signal is lower than the gate high voltage and higher than the pixel driving voltage, and a minimum voltage of the ramp waveform signal is lower than the ground voltage and higher than the gate low voltage.

14. The display device according to claim 12, wherein a lighting period of the light-emitting element becomes longer as the data voltage increases.

15. The display device according to claim 13, wherein the PWM driver includes:
a capacitor arranged between a fourth node and the second gate line;
a second transistor including a first electrode connected to the second node, a gate electrode connected to the first gate line, and a second electrode connected to the second power line;
a third transistor including a first electrode connected to the data line, a gate electrode connected to the first gate line, and a second electrode connected to the fourth node; and
a fourth transistor including a first electrode connected to the second node, a gate electrode connected to the fourth node, and a second electrode connected to the first node.

16. The display device according to claim 15, wherein the light-emitting element starts emitting light when the fourth transistor is turned on, and
wherein the earlier a turn-on timing of the fourth transistor is, the longer a lighting period of the light-emitting element becomes.

17. The display device according to claim 12, wherein the display panel further includes a sensing line connected to a cathode electrode of the light-emitting element, and
wherein the PWM driver is connected to a data line configured to receive the data voltage, a first gate line configured to receive a first gate signal, a second gate line configured to receive a second gate signal, a third gate line configured to receive a third gate signal, the first node, the second node, and the second power line.

18. The display device according to claim 17, further comprising:
a first switch element configured to supply the first gate signal to the third gate line in the display mode, and to supply the third gate signal to the third gate line in a sensing mode; and
a sensing circuit connected to the light-emitting element and operated in the sensing mode.

19. The display device according to claim 18, wherein the sensing circuit includes:
an analog-to-digital converter; and
a second switch element configured to supply the ground voltage to a cathode electrode of the light-emitting element in the display mode and to connect the cathode electrode of the light-emitting element to an input terminal of the analog-to-digital converter in the sensing mode.

20. The display device according to claim 19, wherein the first gate signal is a gate high voltage during an initialization period and a sensing period in the sensing mode, and is a gate low voltage during a sampling period in the sensing mode,
wherein in the sensing mode, a voltage of the second gate signal is maintained at a reference voltage during the initialization period, the sampling period, and the sensing period,
wherein in the sensing mode, a voltage of the third gate signal is the gate low voltage during the initialization period and the sensing period, and is the gate high voltage during the sampling period, and
wherein the PWM driver includes:
a capacitor arranged between a fourth node and the second gate line;
a second transistor including a first electrode connected to the second node, a gate electrode connected to the first gate line, and a second electrode connected to the second power line;
a third transistor including a first electrode connected to the data line, a gate electrode configured to receive the first gate signal in the display mode and configured to receive the third gate signal in the sensing mode, and a second electrode connected to the fourth node; and
a fourth transistor including a first electrode connected to the second node, a gate electrode connected to the fourth node, and a second electrode connected to the first node.
